(19) United States
(12) Patent Application Publication
(10) Pub. No.: US 2026/0319741 A1
(43) Pub. Date: Oct. 15, 2026

(54) GATHER-SUM CIRCUITRY FOR MATRIX MULTIPLICATIONS

(71) Applicant: GOOGLE LLC, Mountain View, CA (US)

(72) Inventors: Sean Purser-Haskell, Sunol, CA (US); Sanjay Ghemawat, Mountain View, CA (US); Jeffrey Adgate Dean, Palo Alta, CA (US)

(21) Appl. No.: 19/646,748

(22) Filed: Apr. 14, 2026

Related U.S. Application Data
(60) Provisional application No. 63/788,967, filed on Apr. 15, 2025.

(51) Int. Cl. G06F 7/53; G06F 13/16; G06F 17/16

(52) U.S. Cl. CPC G06F 7/5318; G06F 13/1689; G06F 17/16

(57) ABSTRACT

An activation vector comprising activation values is received. A plurality of bit vectors is retrieved from a memory, each bit vector associated with a respective weight in a quantized weight column and indicating a clock cycle in which that weight is processed. A matrix multiplication operation is factorized into a plurality of clock cycles to obtain partial products, each clock cycle corresponding to a factor group of activation values associated with a distinct non-zero weight value. For each clock cycle, the activation values corresponding to the factor group are selectively gated using the bit vectors to obtain gated activation values. The gated activation values are added using an adder tree to generate a single sum. A single multiplication of the sum with the distinct non-zero weight value is performed to produce a partial product. The partial products are accumulated across the clock cycles to produce a matrix multiplication output.

### CROSS-REFERENCE TO RELATED APPLICATION(S)

This application claims the benefit of and priority to U.S. Provisional Patent Application Ser. No. 63/788,967, filed Apr. 15, 2025, the entire disclosure of which is incorporated herein.

### BACKGROUND

Machine learning has become a pervasive force across numerous industries, driving advancements in fields such as healthcare, autonomous systems, natural language processing, and image recognition. Its ability to extract patterns from vast datasets and enable predictive modeling has made it a widely adopted tool, with neural networks at the forefront of this technological revolution. From powering real-time decision-making in edge devices to supporting large-scale data analysis in cloud infrastructure, machine learning has seen widespread adoption that reshapes how systems process and interpret information.

As these applications grow in complexity and scale, there is an increasing desire to implement machine learning models directly in hardware to achieve higher performance, lower latency, and improved energy efficiency compared to software-based solutions running on general-purpose processors. This is particularly relevant to feedforward neural networks, where matrix multiplication operations dominate the computational workload during both training and inference phases, and where the sequential propagation of data through multiple layers creates opportunities for specialized hardware to reduce processing time and energy consumption compared to general-purpose computing architectures.

### SUMMARY

One aspect of the disclosed implementations relates to a method for optimizing matrix multiplication in hardware, including: receiving an activation vector including activation values; retrieving, from a memory, a plurality of bit vectors, each bit vector associated with a respective weight at a specific index in a quantized weight column and indicating a respective clock cycle in which the respective weight is processed based on a respective quantized weight value associated with the respective weight; factorizing a matrix multiplication operation into a plurality of clock cycles to obtain respective partial products, each clock cycle corresponding to a factor group of activation values associated with a distinct non-zero weight value, wherein, for each clock cycle, factorizing the matrix multiplication includes: selectively gating, using the plurality of bit vectors, the activation values corresponding to the factor group associated with the distinct non-zero weight value to obtain selectively gated activation values; adding the selectively gated activation values using an adder tree to generate a single sum; and performing a single multiplication of the single sum with the distinct non-zero weight value to produce one of the respective partial products; and accumulating the respective partial products to produce a matrix multiplication output.

One aspect of the disclosed implementations relates to a circuitry for matrix multiplication, including: a memory configured to store a plurality of bit vectors, each bit vector associated with a respective weight at a specific index in a weight column and indicating, across a plurality of clock cycles, a cycle in which the respective weight is processed based on its quantized weight value, the plurality of clock cycles corresponding to a number of possible non-zero weight values defined by a bit width of a plurality of weight values in the weight column; a plurality of gating circuits configured to receive an activation vector including a plurality of activation values and, for each clock cycle of the plurality of clock cycles, apply bits from the plurality of bit vectors to gate the plurality of activation values corresponding to a respective non-zero weight value of the possible non-zero weight values; an adder tree coupled to the plurality of gating circuits, the adder tree configured to sum the plurality of activation values in each clock cycle to produce a partial sum; a multiplier coupled to the adder tree, configured to multiply the partial sum by the respective non-zero weight value in each clock cycle to produce a partial product; and an accumulator coupled to the multiplier, configured to accumulate the partial products over the plurality of clock cycles to produce a matrix multiplication output.

One aspect of the disclosed implementations relates to a circuit for matrix multiplication with common subexpression elimination, including: an activation gather-sum group configured to receive activation values and to sum subsets of the activation values based on gating signals to produce activation partial sums; control logic coupled to the activation gather-sum group and configured to receive the activation partial sums; a partial sum file coupled to the control logic and configured to store the activation partial sums; a partial sums gather-sum group coupled to the partial sum file and configured to sum selected subsets of stored partial sums to produce combined partial sums; a recursion path coupling an output of the partial sums gather-sum group to the control logic, the recursion path configured to return the combined partial sums to the control logic for routing to the partial sum file or to a multiplier; and the multiplier coupled to the control logic and configured to multiply a partial sum by a weight value to produce a partial product for storage in an output buffer.

These and other aspects of the present disclosure are disclosed in the following detailed description of the embodiments, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 illustrates an example of matrix multiplication in the context of machine learning, particularly within neural networks where matrix operations are utilized to process data efficiently.

FIG. 2 is a block diagram that illustrates gather-sum circuitry for matrix multiplications.

FIG. 3 is a block diagram that illustrates scalable gather-sum circuitry for matrix multiplications.

FIG. 4 is a block diagram that illustrates run-length encoding (RLE) circuitry for optimizing memory usage in matrix multiplication.

FIG. 5 is a block diagram that illustrates an example of gather-sum circuitry implemented with Common Subexpression Elimination (CSE) logic for optimizing matrix multiplications.

FIG. 6 is a flowchart of an example of a technique associated with low-power gather-sum circuitry for quantized matrix multiplication in machine learning.

### DETAILED DESCRIPTION

Matrix multiplication is a fundamental operation of modern machine learning, particularly in neural networks where operations like dot products and convolutions dominate computational workloads. Advances in hardware accelerators, such as Graphics Processing Units (GPUs) and Tensor Processing Units (TPUs), have substantially improved the speed and scale of these computations, enabling the widespread adoption of deep learning models for applications ranging from image recognition to natural language processing. However, as neural networks grow in size and complexity, a technical challenge emerges: the power consumption and silicon area required to perform these matrix multiplications efficiently. This issue is especially pronounced in resource-constrained environments like edge devices and data centers, where energy costs and thermal limits increasingly dictate performance boundaries.

Traditional hardware solutions, such as systolic arrays, excel at processing large matrix multiplications but face drawbacks when handling models with low-bit-width weights, a growing trend known as deep quantization aimed at reducing memory and computational overhead. These architectures rely heavily on multiplications for each activation-weight pair, resulting in high power dissipation due to the wide bit widths of intermediate results and the frequent switching of numerous transistors. For example, in a typical systolic array processing a 20,480-element dot product with 4-bit weights, the system performs thousands of multiplications, each widening the adder tree bit width and consuming substantial energy. This inefficiency becomes a bottleneck as power delivery and heat dissipation may not scale proportionally with shrinking transistor sizes in sub-100 nm process nodes, limiting achievable throughput per unit area and driving up operational costs.

The consequences of these inefficiencies extend beyond power consumption to practical deployment challenges. High-energy demands may call for complex cooling systems or throttle clock speeds, reducing real-time inference performance used in latency-sensitive applications. Alternatives using fully unrolled, specialized circuits for quantized models can achieve lower power but sacrifice flexibility, requiring dedicated silicon for each model and incurring significant capital costs for redesigns. Meanwhile, the dynamic nature of neural network workloads, where weight distributions and model sizes vary, further complicates optimization, as fixed architectures struggle to adapt without substantial overhead. Current solutions thus may not adequately balance power efficiency, throughput, and adaptability, leaving a gap for innovations that can leverage quantization potential without compromising on performance or cost.

Implementations according to this disclosure address problems such as these via gather-sum circuitry that receives an activation vector and a weight column with quantized integer weights, typically 4 bits or less, factors the matrix multiplication into a series of clock cycles based on distinct non-zero weight values, and processes each cycle with a bit vector to gate activation values, which are then summed and multiplied once per weight value to produce an output with improved inference efficiency.

This approach leverages quantization where at least the weights are constrained to low-bit-width integers (e.g., 4 bits) and supports hardening of machine learning models into fixed or semi-programmable hardware, reducing the number of multiplication operations to O(2^{N}), where N is the bit width of the weights (e.g., 4 bits yields up to 15 factor groups), compared to traditional element-wise multiplications. A factor group, as used herein, refers to a subset of activation values from an activation vector that are associated with a specific non-zero weight value in the weight column. During the factorization of matrix multiplication, each factor group contains all activation values whose corresponding weights share the same numeric value, allowing them to be processed together in a single clock cycle.

A bit vector, as used herein, is a sequence of bits associated with a specific weight at a specific index in the weight column. Each bit in the vector corresponds to a different clock cycle, with a ‘1’ indicating the specific clock cycle in which that weight should be processed based on its value. For example, in a system with 20,480 weights with 4-bit quantization (allowing values 0-15), each weight would have a 15-bit vector (for non-zero values 1-15) with only one bit set to ‘1’—the bit corresponding to the clock cycle matching the weight value. During each clock cycle, the corresponding bits from all bit vectors are used to selectively gate activation values, allowing only those activation values associated with weights having a specific value to be processed in that cycle.

The gather-sum circuitry employs an adder tree with value gating on each input to sum gated activation values in each clock cycle, followed by a single multiplier at the output, achieving lower power per operation (measured in joules per inference) and higher throughput per square millimeter than traditional multiplication-heavy accelerators. Value gating refers to selectively enabling or disabling each activation value contribution to the sum based on a control signal, such as a bit from a bit vector, such that only relevant values are processed in a given cycle. Gating circuits are circuits that selectively pass or block activation values based on a control signal, such as an AND gate array.

The gather-sum circuitry minimizes power dissipation by exploiting the low duty cycle of wide, quantized dot products, where only a fraction of inputs switch per cycle, and delivers performance akin to fully unrolled, specialized circuits while retaining reusable hardware. The adder tree is a multi-level circuit of adders that reduces a large set of inputs to a single sum through staged pairwise additions. For instance, with 20,480 inputs, the first level might include 10,240 adders summing pairs, progressing through roughly 15 levels to a partial sum. Alternatives include pipelined adder trees with registers for higher clock speeds or configurable trees for varying input widths.

An additional power efficiency advantage of the gather-sum architecture stems from its inherent resilience to glitch power dissipation. The pyramidal structure of the adder tree naturally mitigates switching-related power losses because while deeper layers may experience more switching activity due to timing variations, these layers contain exponentially fewer logic elements. This design intentionally operates with a low duty cycle where most gating circuits are inactive in any given clock cycle, acknowledging that maximizing logic utilization would lead to excessive heat dissipation and may lead to reduced clock speeds to maintain thermal boundaries. By selectively activating only the appropriate (e.g., necessary) portions of the circuit per cycle, the architecture achieves better sustained performance within thermal limitations than designs that generate excessive heat from continuous high-intensity operation.

In some implementations, run-length encoding (RLE) can be used to compress the weight column storage (i.e., the storage of the bit vectors), integrating with gating circuits and parallel adder trees, where the gating circuits, as described, selectively pass activation values to the trees to enable scalable, low-power matrix multiplication optimized for neural network inference. The weights, stored in an RLE format, reduce memory access frequency (e.g., to every 18 cycles for 4-bit weights). The RLE compression becomes particularly effective when applied to sparse weight distributions, as consecutive zeros can be encoded as a single run with minimal storage overhead, thereby reducing both the memory footprint and bandwidth requirements.

While this disclosure primarily describes configurations where weights are organized in columns and activations in rows, it should be understood that the techniques, architectures, and optimizations described herein are equally applicable to alternative matrix layouts, including configurations where weights are organized in rows and activations in columns. The underlying principles of the gather-sum circuitry operate independently of the specific matrix orientation, and implementations may adopt either layout based on specific design considerations, memory access patterns, or integration requirements with existing hardware accelerator architectures. For clarity and consistency, the disclosure will primarily reference the column-oriented weight organization, with the understanding that row-oriented configurations are encompassed within the scope of this disclosure.

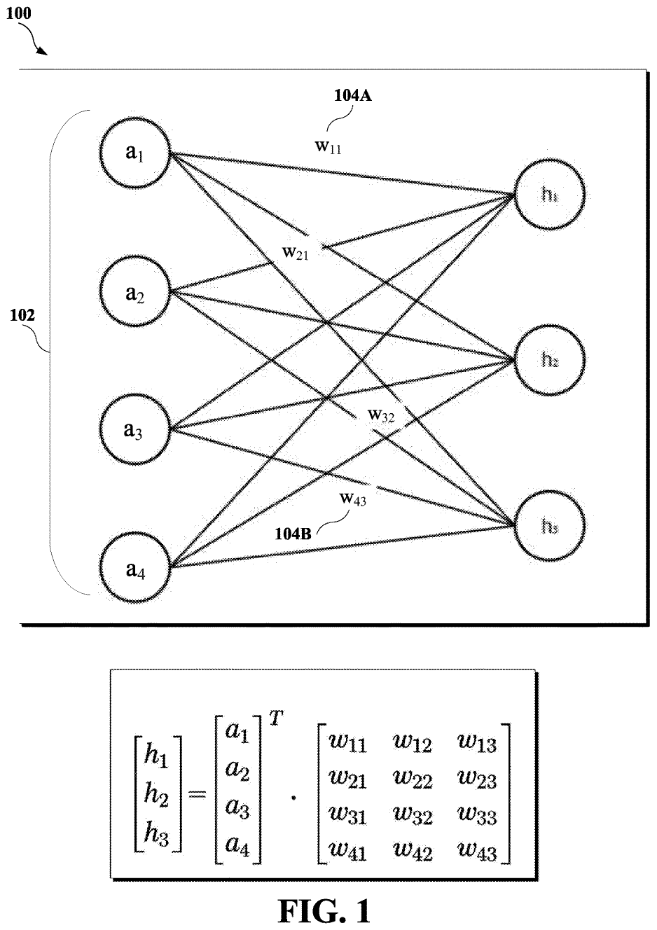

FIG. 1 illustrates an example 100 of matrix multiplication in the context of machine learning, particularly within neural networks where matrix operations are utilized to process data efficiently. The example 100 depicts a simplified representation of a neural network layer, showing how an activation vector 102 interacts with weights wᵢⱼ, such as weights 104A and 104B, to perform matrix multiplication, which forms the basis of computations such as dot products in feedforward layers. In some implementations, the activation vector 102 may represent a set of input activation values from a preceding layer or input data, such as pixel intensities or feature values, arranged as a vector of numerical values. As shown, the activation vector 102 includes a 4×1 vector of activation values, such as [a₁, a₂, a₃, a₄]. The activation vector 102 can include any number of activation values. The examples further described herein use an activation vector that includes 20,480 activation values.

In the general case, the weights (e.g., the weights 104A and 104B) may be floating-point, 8-bit integers, or have some other representation. In some implementations, the weights may represent quantized weight values within a weight column, facilitating the matrix multiplication operation. In some implementations, the weights may correspond to low-bit-width integer values, such as 4-bit weights ranging from 0 to 15, stored in a weight column to connect input nodes to output nodes in a neural network layer, as shown by the connections in FIG. 1. As depicted in the example 100, connections between the activation values of the activation vector 102 and weights represent matrix elements, denoting the individual weight values wᵢⱼ in the weight column W that link each activation to output nodes. For example, the weight 104A might be a value of 1 connecting the activation a₁ to an output, while the weight 104B could be a value of 3 connecting the activation a₂ to another output, forming part of a 4×3 weight column W:

$$W = [ \begin{matrix}{w}_{11} & {w}_{12} & {w}_{13} \\ {w}_{21} & {w}_{22} & {w}_{23} \\ {w}_{31} & {w}_{32} & {w}_{33} \\ {w}_{41} & {w}_{42} & {w}_{43}\end{matrix} ] \qquad ( 1 )$$

The activation vector 102 may be multiplied by the weight column W formed by producing an output vector (H) for the next layer, such as H=A·W, where A is the activation vector and W is the weight column. The output hⱼ for each output node j might be calculated as show in equation (2)

hⱼ=a₁·w₁ⱼ+a₂·w₂ⱼ+a₃·w₃ⱼ+a₄·w₄ⱼ (2)

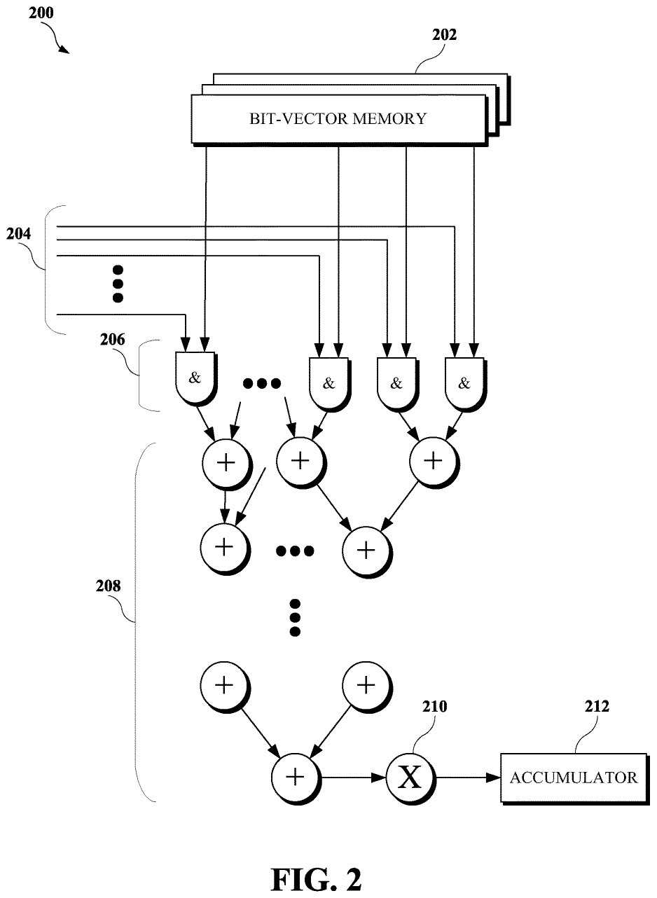

FIG. 2 is a block diagram 200 that illustrates gather-sum circuitry for matrix multiplications, particularly in the context of neural networks for machine learning. The block diagram 200 includes a memory 202 (i.e., a bit-vector memory), an activation vector 204, a gating layer 206, an adder tree 208, a multiplier 210, and an accumulator 212. This circuitry is utilized to perform efficient matrix multiplication operations, such as dot products, for neural network inference, supporting low-bit-width weight values to optimize power and throughput, as described in the disclosure.

The gather-sum circuitry of the disclosure may reduce the number of multiplication operations required for matrix multiplication in neural networks, such as computing dot products in feedforward layers. To illustrate, the gather-sum circuitry may process an activation vector comprising activation values (i.e., a plurality of activation values), such as A=[a₀, a₁, a₂, a₃, a₄, a₅, a₆], and a weight vector comprising quantized weight values, such as W=[3,6,6,2,4,5,3]^{T}, to calculate a dot product h=3a₀+6a₁+6a₂+2a₃+4a₄+5a₅+3a₆. The gather-sum circuitry may factorize this computation by grouping activation values according to distinct non-zero weight values, performing the same operation as h=a₃·2+(a₀+a₆)·3+a₄·4+a₅·5+(a₁+a₂)·6, where each factor group (activations multiplied by the same weight value) is summed using an adder tree and multiplied once by its corresponding weight value, reducing the number of multiplications from 7 to 5, as compared to multiplying each activation value by its weight individually.

The memory 202 may store a plurality of bit vectors that correspond to weights in a weight column used for matrix multiplication. The memory 202 holds (e.g., is structured to hold) data representing quantized weight values, organized to facilitate gating and summation operations across clock cycles. Alternative embodiments might include the memory 202 configured as read-only memory (ROM) with fixed weight values or static random-access memory (SRAM) with programmable weights, adapting to different neural network configurations. The memory 202 includes bit vectors for all columns of the weight matrix.

The “plurality of bit vectors” (or simply “bit vectors”) refers to a collection of binary sequences, each associated with a weight at a specific index in the weight column, where the number of bit vectors equals M (i.e., the number of weight positions in a dot product or column, which corresponds to the length of the activation vector). Each “bit vector” consists of N bits, where N is the number of possible non-zero weight values determined by the bit width of the quantized weight values, enabling cycle-specific gating of activation values. For example, if M=20,480 (corresponding to the number of weights in one column of the weight column or, equivalently, the number of activations in a row of the activation matrix) and the quantized weight values have a 4-bit width, defining 16 possible values (0 to 15), then N=15 for the non-zero values (1 to 15). The memory 202 might store 20,480 15-bit vectors, each with one bit set to 1 and 14 bits set to 0. To reiterate, each 15-bit vector includes a single bit set to 1 and 14 bits set to 0, indicating the specific clock cycle in which the corresponding weight should be processed, given that the matrix multiplication for quantized weight values, such as 4-bit weights, takes 15 clock cycles to complete one dot product, excluding weights with value 0 since multiplication by 0 yields 0 and need not be processed.

Again, a bit vector associated with a weight wᵢ indicates the clock cycle, from a plurality of clock cycles corresponding to possible non-zero weight values defined by a bit width, in which that weight value is to be processed, such as gating the corresponding activation value for summation and multiplication during matrix multiplication. To illustrate, consider the weight vector W=[3, 6, 6, 2, 4, 5, 3, . . . ]. For each weight at a specific index in this vector, there is a corresponding bit vector that indicates in which clock cycle the weight will be processed. For example, the bit vectors associated with the first weight (at index 0, with value 3) and seventh weight (at index 6, also with value 3) would each have their third bit set to 1 (e.g., [0, 0, 1, 0, 0, 0, 0, . . . ]), indicating that these weights are to be processed in the 3rd clock cycle. Similarly, the bit vectors associated with the second weight (at index 1, with value 6) and third weight (at index 2, also with value 6) would each have their sixth bit set to 1 (e.g., [0, 0, 0, 0, 0, 1, 0, . . . ]), indicating that these weights are to be processed in the 6th clock cycle. Each bit vector contains a single 1 in the position corresponding to the weight value at that specific index, with all other positions set to 0.

The activation vector 204 may represent a set of input activation values received for processing in a neural network layer, forming part of a matrix multiplication operation. In some implementations, the activation vector 204 could include a vector of numerical values, such as 8-bit integers, corresponding to outputs from a previous layer or input data like pixel values. To illustrate, and continuing with the above example, the activation vector 204 might include 20,480 elements. The activation vector 204 is held by the gather-sum circuitry for all of the clock cycles corresponding to all of the non-zero quantized weight values. Thus, in the case of 4-bit quantized weight values, the activation vector 204 is held for 15 clock cycles.

The gating layer 206 may include a plurality of gating circuits configured to selectively pass or block activation values from activation vector 204 based on a control signal (e.g., a set of bit vectors) derived (e.g., obtained) from memory 202. In some implementations, gating layer 206 could utilize AND circuitry to apply bit vectors, gating activation values corresponding to a specific non-zero weight value in each clock cycle. For example, with 20,480 activation values, gating layer 206 might include 20,480 AND circuitry, each receiving an activation value and a bit from a 20,480-bit mask, producing gated values for summing in adder tree 208. Alternative embodiments might employ multiplexers, threshold-based circuits, or comparators into the gating logic.

In a given clock cycle X corresponding to a quantized non-zero weight value X, the gating layer 206 may pass all activation values from activation vector 204 that correspond to weight values equal to X in the weight column, allowing them to be provided to adder tree 208 for summation, while blocking other activation values by masking them to 0, such that those blocked activation values have no effect on the summation. In some implementations, this selective passing may be achieved using bits from the plurality of bit vectors stored in memory 202, where for each bit vector associated with a weight having value X, the bit corresponding to the current clock cycle is set to 1, enabling the gating circuits to selectively pass only the activation values associated with weights equal to X during that specific clock cycle of the matrix multiplication.

The adder tree 208 comprises a multi-level circuit of adders that reduces the gated activation values to a single partial sum through staged pairwise additions. To illustrate, for an activation vector with 20,480 8-bit values (each ranging from 0 to 255), the adder tree progresses through approximately 15 levels. At the first level, 10,240 9-bit adders sum pairs of 8-bit gated activation values (maximum sum of 510), producing 9-bit outputs. Subsequent levels increase bit width to accommodate growing sums: level 2 uses 5,120 10-bit adders (maximum sum 1,020), level 3 uses 2,560 11-bit adders (maximum sum 2,040), and so forth, culminating in a single 23-bit partial sum at the final level (maximum possible sum 5,222,400, where log₂(5,222,400)≈22.3, requiring 23 bits). To handle rare overflow cases during summation, the adder tree may implement saturation arithmetic, capping outputs at the maximum representable value (e.g., 2²³⁻¹−1, where N is the bit width of the partial sum, e.g., 4,194,303 for a 23-bit signed sum), facilitating numerical stability without substantial loss of accuracy for downstream multiplications.

Accordingly, the adders within the adder tree 208 may vary in bit width to accommodate the numerical range of the activation values and their summations, where the bit width of each adder may correspond to the precision required at different levels of the tree. To illustrate, and without limitations, the first level of the adder tree 208 may include 9-bit adders, each summing two 8-bit gated activation values to produce a 9-bit output, while subsequent levels might include 10-bit adders to handle the increased range of intermediate sums, such as summing two 9-bit values to produce a 10-bit output, continuing through approximately 15 levels until a single partial sum is generated. Alternative embodiments might employ adders of varying bit widths, such as 8-bit adders for lower-precision inputs or 16-bit adders for higher-precision models, adjusting to the quantization and scale of the neural network activation and weight values as described in the disclosure.

The multiplier 210 is coupled to adder tree 208 and configured to multiply the partial sum produced by the adder tree 208 by a respective non-zero weight value in each clock cycle. In some implementations, the multiplier 210 could perform, for example, a single 23×8-bit multiplication, multiplying the partial sum (e.g., a 23-bit value from summing 8-bit activations) by a weight value received on an 8-bit input port that accommodates weight operands of varying bit-widths up to 8 bits. In the case of 4-bit quantized weights, the weight value (e.g., a value between 1 and 15) occupies the lower 4 bits of the 8-bit input to produce a weighted partial sum. For example, if the adder tree 208 outputs Sum₁=500 for a weight value of 13, the multiplier 210 might compute 500×13=6,500, contributing to the dot product.

The multiplier 210 may receive the weight value corresponding to the current clock cycle through various configurations. For example, the multiplier 210 might be coupled to a counter (not shown) that tracks the clock cycle number, where the counter increments from 1 to a number of possible non-zero weight values defined by a bit width of the quantized weight values, such as 15 cycles for 4-bit weights, and outputs the corresponding weight value (e.g., cycle 1 outputs weight 1, cycle 2 outputs weight 2). In other implementations, the processing order of weight values across clock cycles may be arbitrary, such that the sequence need not correspond numerically to the weight values themselves. The bit vectors stored in memory may encode any one-to-one mapping between clock cycles and non-zero weight values, with the multiplier receiving the appropriate weight value for each cycle through the control logic or a lookup table. Alternatively, the multiplier 210 could be connected to memory 202 or a separate weight register, receiving a decoded weight value derived from the bit vectors. In other embodiments, the multiplier 210 might interface with a lookup table or control logic that maps clock cycle indices to precomputed weight values.

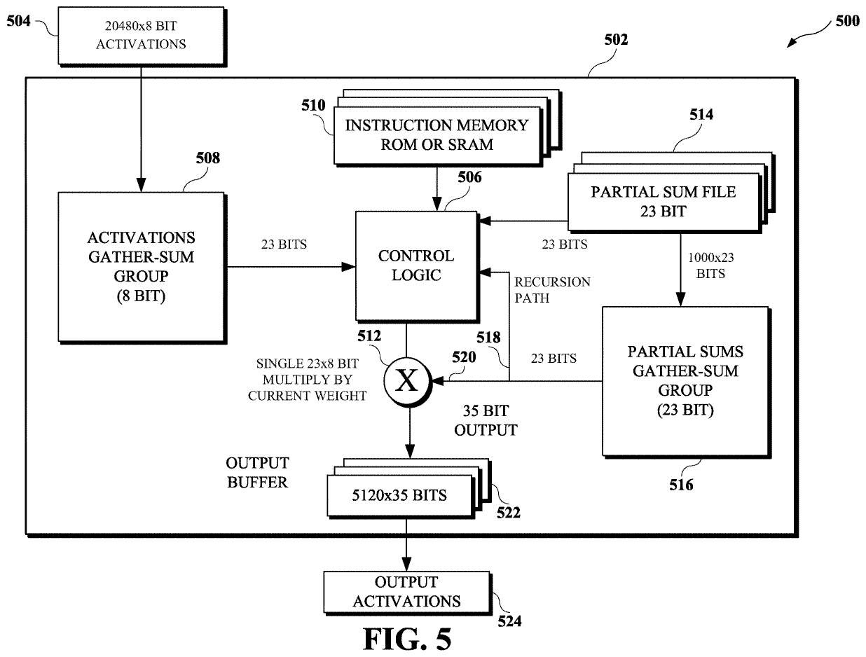

The accumulator 212 is coupled to multiplier 210 and configured to accumulate the weighted partial sums over the plurality of clock cycles to produce an output value for the matrix multiplication. In some implementations, accumulator 212 could store and sum results in a 34-bit register, accumulating values over all (e.g., 15 clock cycles) yielding the dot product output. The output bit-width may vary depending on the number of partial products accumulated. For example, a 4-bit weight implementation accumulating 15 partial products may use a 34-bit register, while implementations with wider weight bit-widths or additional accumulation stages, such as those incorporating CSE as described with respect to FIG. 5, may use wider registers, such as 35-bit or 64-bit, to accommodate the increased range of accumulated values. Alternative embodiments might include reset mechanisms for sequential dot products.

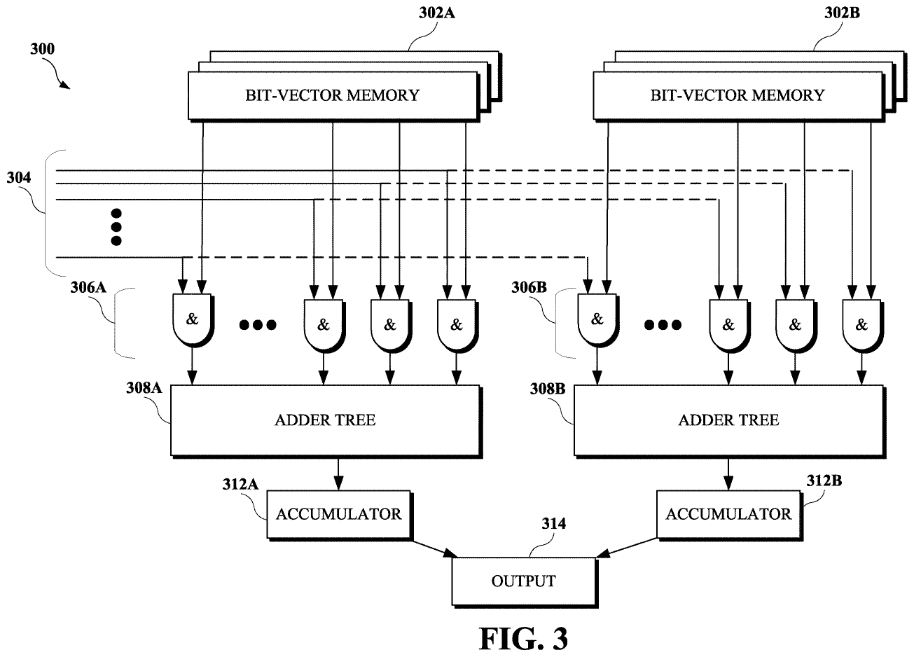

FIG. 3 is a block diagram 300 that illustrates scalable gather-sum circuitry for matrix multiplications, particularly in the context of neural networks for machine learning, demonstrating the duplication of the structure to enhance throughput. The block diagram 300 includes two parallel instances, mask memory 302A and mask memory 302B, gating layers 306A and 306B, adder trees 308A and 308B, and accumulators 312A and 312B connected to a shared activation vector 304 and outputting to an output 314. The output 314 collects the results from accumulators 312A and 312B, providing the completed dot product outputs for further processing.

The architecture additionally supports vertical slicing configurations, where the gather-sum structure can be implemented with reduced width to accommodate area constraints, processing fewer activation values in parallel while distributing computation across additional clock cycles. For example, a half-width implementation could process a 20,480-element dot product in approximately 30 cycles instead of the 15 cycles required for 4-bit weights in a full-width configuration, by partitioning the activation values and corresponding bit vectors into two sequential processing passes. This flexible scaling approach enables power-area-performance tradeoffs, allowing designers to optimize for reduced silicon area with narrower adder trees and gating structures while maintaining functional equivalence through additional sequential steps.

The total memory size remains unchanged as compared to the size of the memory 202 of FIG. 2, with mask memory 302A and 302B collectively storing bit vectors for different weight columns of the weight matrix, such as subsets of 20,480 weights each, without increasing overall memory area. Each duplicated structure may be dedicated to processing specific weight columns, enabling parallel computation of multiple dot products efficiently for neural network inference. For example, the left structure of FIG. 3 may be dedicated to handling odd numbered weight columns and the right structure of FIG. 3 may be dedicated to handling even numbered weight columns. While FIG. 3 shows only 2 structures, the disclosure is not so limited and implementations may include more structures. Alternatively, the architecture supports flexible memory partitioning where weights can be horizontally sliced and rearranged across processing elements, allowing mask memory 302A to store bit vectors for the first half of weights while mask memory 302B stores the second half, processing a complete dot product over 30 cycles (15 cycles per half) rather than processing different columns in parallel.

Duplicating the gather-sum structures, as shown in FIG. 3 with two instances (mask memory 302A/302B, gating layers 306A/306B, adder trees 308A/308B, and accumulators 312A/312B), increases throughput by enabling parallel processing of multiple columns of the weight matrix using the same activation vector 304, compared to the single-structure configuration in FIG. 2. For example, the adder tree 208 of FIG. 2 and the associated components may process one dot product (e.g., 20,480 activation values×one column of weights) over 15 clock cycles, producing one output value per cycle sequence, whereas the two parallel structures of FIG. 3 may concurrently compute dot products for two distinct 20,480-element weight columns, potentially doubling the throughput to two output values per 15 clock cycles, without increasing memory size. Again, alternative embodiments might scale to additional duplicated structures, such as four or sixteen, further increasing throughput proportionally while maintaining memory efficiency, adapting to the scale and requirements of neural network matrix multiplications.

The scaling approach demonstrated in FIG. 3 offers additional advantages from a physical implementation perspective. By dividing the architecture into smaller memory units that remain physically proximate to their corresponding adder tree structures, the design maintains shorter interconnect lengths and reduces signal propagation delays across the integrated circuit floor plan. This partitioning approach enables more efficient placement and routing during physical design, improving timing closure and reducing power consumption associated with long-distance signal transmission.

Furthermore, the architecture can be scaled below a full adder tree implementation when area or power constraints are paramount. For example, a half-tree configuration could be implemented that processes the same computation over 30 cycles instead of 15, by appropriately rearranging the gating and weight bits to accommodate the reduced hardware. This flexibility extends to the accumulation stage as well, where partial sums can be stored before multiplication, enabling fine-grained trade-offs between throughput, power consumption, and silicon area based on specific application requirements. These scaling options make the gather-sum architecture adaptable across a wide range of deployment scenarios, from resource-constrained edge devices to high-performance accelerators.

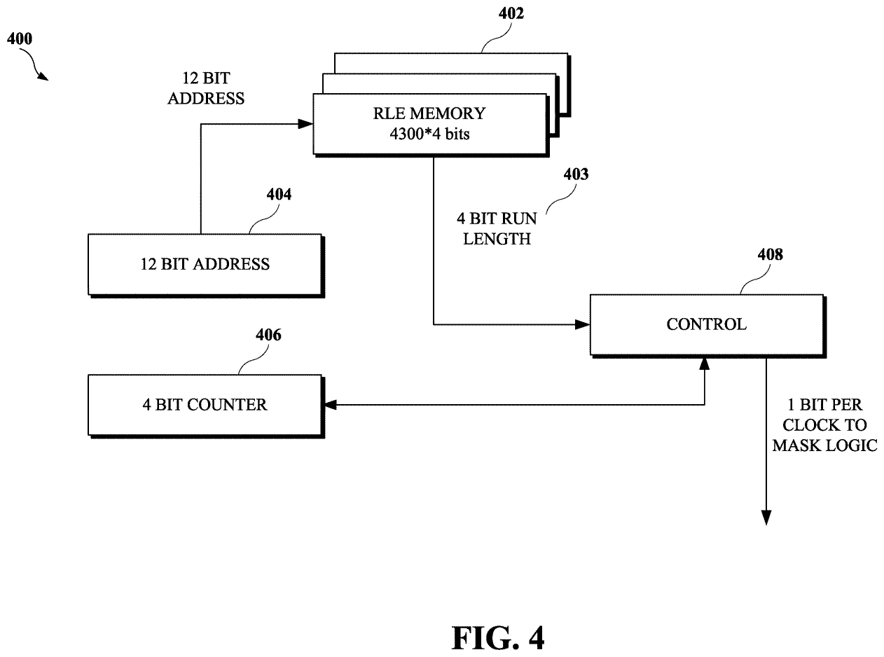

FIG. 4 is a block diagram 400 that illustrates run-length encoding (RLE) circuitry for optimizing memory usage in matrix multiplication, particularly for neural networks in the disclosure, enhancing the efficiency of weight data storage and access. The block diagram 400 includes an RLE memory 402, a 4-bit run length 403, a 12-bit address 404, a 4-bit counter 406, and a control 408, with an output of 1 bit per clock to mask logic, facilitating the generation of bit vectors for gating operations.

The motivation for incorporating run-length encoded data in the gather-sum circuitry stems from the memory overhead of storing uncompressed weight data for large neural networks. As mentioned above, and to illustrate, each 4-bit quantized weight value might be associated with a bit vector, such as 15 bits, to indicate its clock cycle, adding considerable memory when handling many weights, increasing power and area. RLE may compress this data, leveraging sparsity and repetitive patterns, reducing memory usage and access frequency to enhance efficiency for neural network inference.

The 12-bit address 404 may provide an address input to access data in RLE memory 402, enabling retrieval of compressed weight information for matrix multiplication. In some implementations, the 12-bit address 404 could specify a location within RLE memory 402, corresponding to weight values for an activation vector. Alternative embodiments might use different bit widths for addressing, adjusting to various memory configurations.

The RLE memory 402 stores run-length encoded data representing gating bit sequences for the quantized weight values, compressing sequences of identical weights (e.g., consecutive weights of 1) into run lengths and values, reducing memory footprint and power consumption compared to uncompressed bit vectors, as described in the disclosure. This approach focuses on efficiently encoding the binary gating signals rather than the weights themselves, which enables the circuit to recover the performance benefits of sparsity in the weight distribution. The primary function of the RLE memory is to provide the necessary gating values on a per-cycle basis, with memory requirements that scale advantageously with the sparsity of the weight matrix. As the number of zero-valued weights increases in the quantized weight matrix, longer runs of identical gating bits can be encoded more efficiently, allowing the memory subsystem to adapt dynamically to the sparsity characteristics of different neural network layers. Alternative embodiments might use other compression schemes, adapting to weight distribution patterns in neural networks.

The 4-bit run length 403 may represent the length of consecutive identical weight values in the RLE format, facilitating efficient decoding for matrix multiplication. In some implementations, the 4-bit run length 403 could indicate a count of identical weights, stored with a weight value. Alternative embodiments might use different bit widths for run lengths, adjusting to expected weight patterns. The 12-bit address 404 may provide an address to the RLE memory 402 for retrieving compressed weight data, with the address updated by the control 408 based on decoded run lengths. Alternative embodiments might use dynamic or multiple address lines, adapting to memory needs.

The 4-bit counter 406 may track the progression of decoding RLE data, counting through run lengths to generate bit vectors for each clock cycle. In some implementations, the 4-bit counter 406 could increment to decode runs of identical weights into gating bits. Alternative embodiments might use different bit widths or integrated logic, adjusting to neural network sparsity. The control 408 (control logic) may manage the decoding and output of RLE data, generating a 1-bit-per-clock signal to mask logic for gating operations. In some implementations, control 408 could orchestrate RLE decoding to produce bit masks for gating layer 206. Alternative embodiments might use state machines or programmable logic, adapting to RLE variations.

FIG. 4 may integrate with FIG. 2 by replacing or augmenting memory 202 with RLE memory 402, enhancing the gather-sum circuitry for matrix multiplication in neural networks. In some implementations, RLE memory 402 could provide compressed bit vectors to gating layer 206, reducing memory access frequency compared to bit vectors of the memory 202, while the components decode data for mask logic. Alternative embodiments might parallelize RLE decoding or use hybrid memory approaches.

FIG. 5 is a block diagram 500 that illustrates an example of gather-sum circuitry 502 implemented with Common Subexpression Elimination (CSE) logic for optimizing matrix multiplications, particularly in neural networks for machine learning. CSE is an optimization technique that identifies and reuses repeated partial computations across multiple dot products in a matrix multiplication. This configuration enhances computational efficiency by reusing partial sums, partial products, or both across multiple dot products within a matrix operation. The circuitry 502 includes an activation processing path comprising an activation input 504 and an activation gather-sum group 508. In one example, the activation input 504 may include a vector of 20,480 8-bit activations, though other dimensions and bit-widths may be utilized.

The circuitry 502 further includes control logic 506 coupled to an instruction memory 510, which may be implemented as ROM, SRAM, or other suitable storage. The instruction memory 510 may store weight values for the multiplier 512 as well as control instructions that direct the control logic 506 in coordinating the CSE operations, such as specifying which partial sums from the partial sum file 514 to combine in a given cycle and how to route results through the recursion path 518. In some implementations, the instruction memory 510 may be separate from the bit-vector memory used for gating (such as the memory 202 of FIG. 2), while in other implementations, a unified memory structure may serve both functions.

The control logic 506 may be configured to coordinate the operation of a multiplier 512 and a partial sum processing path. The partial sum processing path includes a partial sum file 514 and a partial sums gather-sum group 516. The partial sums gather-sum group 516 operates on partial sums (e.g., 23-bit values) rather than activation values (e.g., 8-bit values), and accordingly may include adders with wider bit-widths at each level compared to the activation gather-sum group 508, to accommodate the larger input operand size. The partial sum file 514 is configured to store intermediate results (e.g., 23-bit partial sums) generated during previous clock cycles or from different columns of a weight matrix. A recursion path 518 connects the output of the partial sums gather-sum group 516 back to the control logic 506, allowing the circuitry 502 to return and route accumulated partial sums to the partial sum file 514 or the multiplier 512 for subsequent reuse.

During operation, the control logic 506 may identify common subexpressions within the matrix multiplication, such as identical activation-weight product pairs or identical sums of activation subsets, and retrieve them from the partial sum file 514 rather than recomputing them through the primary activation gather-sum group 508. The multiplier 512 performs a single multiplication (e.g., a 23×8 bit multiplication) using a weight provided by the control logic 506 to produce a partial product. The partial product, shown as a 35-bit output 520 in the example of FIG. 5, is collected in an output buffer 522, which may be sized to accommodate the specific dimensions of the output matrix (e.g., 5,120 elements of 35 bits each), to produce final output activations 524.

By reusing partial sums through the partial sums gather-sum group 516 and the recursion path 518, the circuitry 502 can reduce the total number of multiplication and addition operations required for large-scale neural network inference. In some implementations, the circuitry may employ CSE to reuse partial sums or products, such as activation-weight products (e.g., a particular activation multiplied by a particular weight value) and sums of activation subsets, reducing multiplications across the matrix. For example, in a matrix multiplication involving a 20,480-element activation vector and a 5,120-column weight matrix, CSE may achieve up to approximately 50% reduction in the number of multiply-accumulate operations by identifying and reusing repeated partial computations across different dot products.

FIG. 5 may integrate with FIG. 2 by extending the gather-sum circuitry to include CSE, reducing redundant computations for matrix multiplication in neural networks. In some implementations, the activation gather-sum group 508, instruction memory 510, and partial sum file 514 of FIG. 5 could enhance the corresponding components of FIG. 2 (memory 202, gating layer 206, adder tree 208, multiplier 210, and accumulator 212), reusing partial sums or products to reduce the number of required multiplications when processing multiple weight columns, such as for 5,120 columns, while maintaining flexibility with ROM or SRAM. Alternative embodiments might combine CSE with RLE or parallel structures, optimizing large-scale neural network inference.

In some implementations, when activation values are constrained to sufficiently low bit widths similar to the quantized weights, the gather-sum structure may be adapted to perform multiplication by activation values rather than weights, providing additional flexibility in neural network acceleration. In some implementations, another mode of operation for larger bit-widths can be to factorize by powers of two, or by arbitrary integer factors. While this mode may not provide the same power benefits for reducing multiplication count (since a single activation may be ungated in multiple factor groups), it may still achieve benefits due to reduced bit-width of additions and efficient summation of arbitrary groups of inputs, without requiring as large of a clock frequency increase to maintain throughput per unit area. Arbitrary integer factors can be practical for weights because the value gating bits are pre-computed, and the number of multiplications by these factors needed is relatively small.

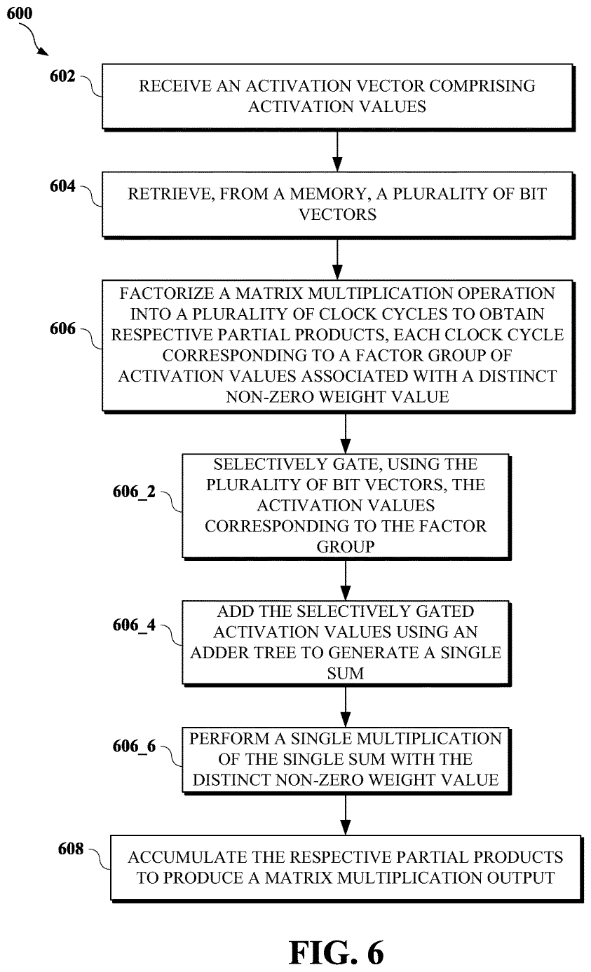

To further describe some implementations in greater detail, reference is next made to examples of techniques which may be performed by or using gather-sum circuitry for optimizing matrix multiplication in hardware as described herein. FIG. 6 is a flowchart of an example of a technique 600 associated with low-power gather-sum circuitry for quantized matrix multiplication in machine learning. The technique 600 can be executed using gather-sum circuitry described with respect to FIGS. 1-5. The steps, or operations, of the technique 600, or another technique, method, process, or algorithm described in connection with the implementations disclosed herein can be implemented directly in hardware, firmware, software executed by hardware, circuitry, or a combination thereof.

At 602, the technique 600 includes receiving an activation vector comprising a plurality of activation values. For example, a gather-sum circuitry, such as the circuitry shown in FIG. 2, may receive an activation vector, such as the 20,480-element vector herein, representing input data like pixel intensities or feature values from a neural network layer.

At 604, the technique 600 includes retrieving, from a memory, a plurality of bit vectors, each bit vector associated with a respective weight at a specific index in a quantized weight column and indicating a respective clock cycle in which the respective weight is processed based on a respective quantized weight value associated with the respective weight. For instance, the gather-sum circuitry of FIG. 2 may access the memory 202, which stores 20,480×15-bit vectors for a 4-bit weight column, each vector tied to a weight position (e.g., w₀, w₁, etc.) and marking its processing cycle (e.g., cycle 3 for weight value 3). In some implementations, the memory may be configured as a read-only memory (ROM) to fix quantized weight values for a specific neural network model, optimizing inference efficiency, as noted in the disclosure.

At 606, the technique 600 includes factorizing a matrix multiplication operation into a plurality of clock cycles to obtain respective partial products, each clock cycle corresponding to a factor group of activation values associated with a distinct non-zero weight value. As such, matrix multiplication (e.g., the dot product of an activation row by a weights column) can be broken (e.g., split) into cycles based on distinct non-zero weight values, such as 15 cycles for 4-bit weights (values 1-15), reducing multiplications from 20,480 to 15, as described herein. Within this step, sub-steps 606_2 through 606_6 are performed for each clock cycle.

At 606_2, the technique 600 includes selectively gating, using the plurality of bit vectors, the activation values corresponding to the factor group associated with the distinct non-zero weight value to obtain selectively gated activation values. Selectively gating, as used herein, refers to the process of conditionally passing or blocking activation values based on their associated weight values using control signals derived from bit vectors. This gating operation enables only the activation values corresponding to a specific weight value to contribute to the computation in a given clock cycle, while effectively masking all other activation values to zero. For example, in cycle 3 for weight value 3, the gating layer 206 of FIG. 2 may use the 3rd bit of each weight 15-bit vector to pass or block activations via 20,480 AND circuits. In alternative embodiments, multiplexers could replace AND circuits for enhanced precision or threshold-based circuits might adapt to weight distributions, as suggested in the disclosure.

At 606_4, the technique 600 includes adding the selectively gated activation values using an adder tree to generate a single sum. For instance, the adder tree 208 of FIG. 2 may sum ~1,300 gated 8-bit activations through 15 levels of 9-bit to 23-bit adders, producing a partial sum. Alternative embodiments might use pipelined adder trees with registers for higher clock speeds or adjustable-depth trees for varying input widths, enhancing flexibility.

At 606_6, the technique 600 includes performing a single multiplication of the single sum with the distinct non-zero weight value to produce one of the respective partial products. For example, the multiplier 210 of FIG. 2 may multiply a 23-bit sum by a 4-bit weight to yield a partial product. In some implementations, the multiplier may couple to a counter tracking clock cycles to retrieve the weight value, or interface with a lookup table, as described in alternative embodiments.

At 608, the technique 600 includes accumulating the respective partial products over the plurality of clock cycles to produce a matrix multiplication output. Accumulating the respective partial products, as used herein, refers to the process of sequentially adding the weighted partial sums generated in each clock cycle to a running total maintained in a register. This accumulation occurs over the complete series of clock cycles (corresponding to all non-zero weight values) and produces the final matrix multiplication output once all partial products have been incorporated. For instance, the accumulator 212 of FIG. 2 may store and sum partial products over 15 cycles to generate a dot product output, such as for a neural network layer.

In some implementations, the quantized weight column may include weights quantized to any bit width N, resulting in 2\hat{ }N−1 cycles corresponding to the possible non-zero weight values. For example, the quantized weight column may include weights quantized to 4 bits or fewer, and the plurality of clock cycles may be limited to 15 or fewer cycles corresponding to non-zero weight values from 1 to 15, thereby achieving a balance of efficiency and accuracy at this bit width.

In some implementations, if certain non-zero weight values are not present in (absent from) a given weight column, the corresponding clock cycles may be skipped, reducing the number of clock cycles below 2\hat{ }N−1 for that particular dot product and providing additional power and latency savings proportional to the sparsity of the distinct weight values in the column.

The technique 600 may also include processing multiple columns of the quantized weight column in parallel by duplicating the adder tree, where the memory may be split across the duplicated adder trees without increasing total memory size, thereby increasing throughput, as shown in FIG. 3 and described for scalable gather-sum circuitry. For example, two parallel structures (e.g., mask memory 302A/302B, adder trees 308A/308B) could handle odd/even columns of the weight matrix, doubling throughput while maintaining memory efficiency.

Additionally, the memory may be or include a run-length encoded (RLE) memory, and accessing the memory may include decoding the RLE memory to generate the plurality of bit vectors, reducing memory access frequency based on the sparsity pattern of the weight values. For example, with moderately sparse 4-bit weights, memory access frequency might be reduced to approximately one access every several clock cycles, with greater reductions possible for weight distributions with higher sparsity. This optimization exploits sparsity in weight distributions, potentially reducing power consumption. RLE memory, as used herein, refers to a memory structure that stores weight information in a compressed format, rather than storing each weight individually. This RLE memory includes dedicated hardware for decoding the compressed data to generate appropriate bit vectors for the gating operations, substantially reducing memory footprint and access frequency compared to uncompressed storage formats.

In further implementations, selectively gating may include applying a plurality of AND circuitry, each AND circuitry receiving an activation value and a bit from the plurality of bit vectors corresponding to the respective clock cycle, to pass or block the activation value, as specified in the disclosure for the operation of the gating layer. Alternative embodiments might employ multi-bit masks or threshold-based gating for enhanced precision, adapting to varying neural network workloads.

The technique 600 may also include storing the respective partial sums in a partial sum file and reusing the respective partial sums across multiple matrix multiplication operations using CSE to reduce the number of multiplication operations, as described in FIG. 5. For instance, partial sums, such as a sum of activation values sharing a common weight value across different columns, could be reused across a 20,480×5,120 matrix, lowering power and improving throughput, with alternative embodiments scaling CSE to additional parallel trees for ultra-wide matrices. In the context of gather-sum circuitry, CSE allows for the storage and reuse of partial products or partial sums that appear multiple times in the computation, such as when the same activation values are multiplied by the same weight values across different output nodes, thereby reducing the total number of multiplication operations required.

The technique 600 may be implemented as a circuit for matrix multiplication. The circuit may include a memory, a plurality of gating circuits, an adder tree, a multiplier, and an accumulator.

The memory can be configured to store a plurality of bit vectors. Each bit vector may be associated with a respective weight at a specific index in a weight column and indicating, across a plurality of clock cycles, a cycle in which the respective weight is processed based on its quantized weight value. The plurality of clock cycles correspond to a number of possible non-zero weight values defined by a bit width of a plurality of weight values in the weight column. In an implementation, the bit width can be up to at least 8 bits, with practical implementations often using 4 bits or fewer. For example, a 4-bit implementation corresponds to up to 15 non-zero weight values, and the plurality of clock cycles is limited to 15 cycles, while an 8-bit implementation would correspond to up to 255 non-zero weight values with 255 cycles. More generally, the quantized weight column includes weights quantized to N bits or fewer, and the plurality of clock cycles is limited to 2\hat{ }N−1 or fewer cycles corresponding to non-zero weight values from 1 to 2\hat{ }N−1. In an implementation, the memory includes a run-length encoded (RLE) memory, and the circuitry includes a decoder configured to decode the RLE memory to generate the plurality of bit vectors, reducing memory access frequency.

The plurality of gating circuits can be configured to receive an activation vector that includes a plurality of activation values. For each clock cycle of the plurality of clock cycles, the plurality of gating circuits apply bits from the plurality of bit vectors to gate the plurality of activation values corresponding to a respective non-zero weight value of the possible non-zero weight values. The plurality of gating circuits may be or include a plurality of AND circuitry where each AND circuitry receives an activation value from the activation vector and a bit from the plurality of bit vectors corresponding to the respective clock cycle, to pass or block the activation value.

The adder tree is coupled to the plurality of gating circuits and is configured to sum the plurality of activation values in each clock cycle to produce a partial sum. The multiplier is coupled to the adder tree and is configured to multiply the partial sum by the respective non-zero weight value in each clock cycle to produce a partial product. The accumulator is coupled to the multiplier and is configured to accumulate the partial products over the plurality of clock cycles to produce a matrix multiplication output.

The circuitry may further include multiple parallel adder trees. Each adder tree is configured to process a distinct column of the weight column and the memory can be split across the parallel adder trees without increasing total memory size, thereby increasing throughput. When memory is split across the parallel adder trees, as used herein, it means that the total weight data is partitioned into separate memory segments, each dedicated to serving a specific adder tree without increasing the overall memory footprint.

For simplicity of explanation, the technique 600 of FIG. 6 is depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, semiconductor device, or circuit. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method for optimizing matrix multiplication in hardware, comprising:
receiving an activation vector comprising activation values;
retrieving, from a memory, a plurality of bit vectors, each bit vector associated with a respective weight at a specific index in a quantized weight column and indicating a respective clock cycle in which the respective weight is processed based on a respective quantized weight value associated with the respective weight;
factorizing a matrix multiplication operation into a plurality of clock cycles to obtain respective partial products, each clock cycle corresponding to a factor group of activation values associated with a distinct non-zero weight value, wherein, for each clock cycle, factorizing the matrix multiplication comprises:
selectively gating, using the plurality of bit vectors, the activation values corresponding to the factor group associated with the distinct non-zero weight value to obtain selectively gated activation values;
adding the selectively gated activation values using an adder tree to generate a single sum; and
performing a single multiplication of the single sum with the distinct non-zero weight value to produce one of the respective partial products; and
accumulating the respective partial products to produce a matrix multiplication output.

2. The method of claim 1, wherein the quantized weight column comprises weights quantized to N bits or fewer, and the plurality of clock cycles is limited to 2\hat{ }N−1 or fewer cycles corresponding to non-zero weight values from 1 to 2\hat{ }N−1.

3. The method of claim 1, wherein the memory comprises a run-length encoded (RLE) memory, and accessing the memory includes decoding the RLE memory to generate the plurality of bit vectors, reducing memory access frequency based on a sparsity pattern of the weight values.

4. The method of claim 1, further comprising:
processing multiple columns of the quantized weight column in parallel by duplicating the adder tree, wherein the memory is split across the duplicated adder trees without increasing total memory size, thereby increasing throughput.

5. The method of claim 1, wherein selectively gating comprises:
applying a plurality of AND circuitry, each AND circuitry receiving an activation value and a bit from the plurality of bit vectors corresponding to the each clock cycle, to pass or block the activation value.

6. The method of claim 1, further comprising:
storing the respective partial sums in a partial sum file; and
reusing the respective partial sums across multiple matrix multiplication operations using common subexpression elimination (CSE).

7. The method of claim 1, wherein the memory is configured as a read-only memory (ROM) to fix quantized weight values for a specific neural network model.

8. The method of claim 1, wherein if certain non-zero weight values are not present in the quantized weight column, clock cycles corresponding to non-zero weight values not present in the quantized weight column are skipped, reducing a number of clock cycles below a total number of possible non-zero weight values for the matrix multiplication operation.

9. The method of claim 1, wherein a processing order of the distinct non-zero weight values across the plurality of clock cycles is independent of a numerical sequence of the distinct non-zero weight values, and the plurality of bit vectors encode a one-to-one mapping between the plurality of clock cycles and the distinct non-zero weight values.

10. The method of claim 1, wherein the adder tree comprises a plurality of levels, and adders at subsequent levels of the adder tree have increasing bit-widths to accommodate growing intermediate sums, with a first level of the adder tree comprising adders having a bit-width one bit wider than a bit-width of the activation values.

11. The method of claim 1, wherein a multiplier performing the single multiplication receives the distinct non-zero weight value on an input port having a fixed bit-width wider than a bit-width of the quantized weight value, and the distinct non-zero weight value occupies fewer bits than the fixed bit-width of the input port.

12. A circuitry for matrix multiplication, comprising:
a memory configured to store a plurality of bit vectors, each bit vector associated with a respective weight at a specific index in a weight column and indicating, across a plurality of clock cycles, a cycle in which the respective weight is processed based on its quantized weight value, the plurality of clock cycles corresponding to a number of possible non-zero weight values defined by a bit width of a plurality of weight values in the weight column;
a plurality of gating circuits configured to receive an activation vector comprising a plurality of activation values and, for each clock cycle of the plurality of clock cycles, apply bits from the plurality of bit vectors to gate the plurality of activation values corresponding to a respective non-zero weight value of the possible non-zero weight values;
an adder tree coupled to the plurality of gating circuits, the adder tree configured to sum the plurality of activation values in each clock cycle to produce a partial sum;
a multiplier coupled to the adder tree, configured to multiply the partial sum by the respective non-zero weight value in each clock cycle to produce a partial product; and
an accumulator coupled to the multiplier, configured to accumulate the partial products over the plurality of clock cycles to produce a matrix multiplication output.

13. The circuitry of claim 12, wherein the bit width is 8 bits or fewer.

14. The circuitry of claim 12, wherein the memory comprises a run-length encoded (RLE) memory, and the circuitry includes a decoder configured to decode the RLE memory to generate the plurality of bit vectors.

15. The circuitry of claim 12, further comprising:
multiple parallel adder trees, each processing a distinct column of the weight column, wherein the memory is split across the parallel adder trees without increasing total memory size.

16. The circuitry of claim 12, wherein the plurality of gating circuits comprises a plurality of AND circuitry, each AND circuitry receiving an activation value from the activation vector and a bit from the plurality of bit vectors corresponding to the respective clock cycle, to pass or block the activation value.

17. A circuit for matrix multiplication with common subexpression elimination, comprising:
an activation gather-sum group configured to receive activation values and to sum subsets of the activation values based on gating signals to produce activation partial sums;
control logic coupled to the activation gather-sum group and configured to receive the activation partial sums;
a partial sum file coupled to the control logic and configured to store the activation partial sums;
a partial sums gather-sum group coupled to the partial sum file and configured to sum selected subsets of stored partial sums to produce combined partial sums;
a recursion path coupling an output of the partial sums gather-sum group to the control logic, the recursion path configured to return the combined partial sums to the control logic for routing to the partial sum file or to a multiplier; and
the multiplier coupled to the control logic and configured to multiply a partial sum by a weight value to produce a partial product for storage in an output buffer.

18. The circuit of claim 17, wherein the partial sums gather-sum group comprises adders having wider bit-widths at each level compared to adders of the activation gather-sum group, to accommodate a bit-width of the stored partial sums that is larger than a bit-width of the activation values.

19. The circuit of claim 17, further comprising an instruction memory coupled to the control logic, the instruction memory configured to store weight values for the multiplier and to store control instructions, the control instructions configured to direct the control logic in coordinating common subexpression elimination operations, including specifying which partial sums from the partial sum file to combine in a given cycle and how to route results through the recursion path.

20. The circuit of claim 17, wherein the activation gather-sum group comprises a plurality of gating circuits configured to apply bits from a plurality of bit vectors stored in a memory to selectively pass or block the activation values in each of a plurality of clock cycles, each clock cycle corresponding to a distinct non-zero weight value, and an adder tree within the activation gather-sum group is configured to sum the selectively passed activation values to produce the activation partial sums.
